(19) United States
(12) Patent Application Publication
(10) Pub. No.: US 2009/0328016 A1
(43) Pub. Date: Dec. 31, 2009

(54) GENERALIZED EXPRESSION TREES

(75) Inventors: Timothy Yat Tim Ng, Bellevue, WA (US); Robert Elliott Viehland, Seattle, WA (US); James Hugunin, Mercer Island, WA (US); Samuel Y. Ng, Belleview, WA (US); Matthew J. Warren, Redmond, WA (US); Anders Hejlsberg, Seattle, WA (US); Henricus Johannes Maria Meijer, Mercer Island, WA (US); John Wesley Dyer, Monroe, WA (US); Avner Y. Aharoni, Seattle, WA (US); John Benjamin Messerly, Seattle, WA (US); Martin Maly, Redmond, WA (US); William P. Chiles, Seattle, WA (US); Mads Torgersen, Issaquah, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/163,775

(22) Filed: Jun. 27, 2008

(51) Int. Cl. G06F 9/44

(52) U.S. Cl. 717/143

(57) ABSTRACT

Expression tree versatility and applicability are enhanced to facilitate programming across various program languages and execution contexts. An expression tree can represent programmatic code as data in a representation common to multiple process mechanisms. As a result, entire programs or portions thereof can be captured and processed by a numerous common language components. Further, language specific concepts can be reduced to the common representation to enable language independent employment.

### BACKGROUND

A programmer utilizing a programming language creates instructions comprising a computer program. Typically, source code is specified or edited by a programmer manually and/or with help of an integrated development environment (IDE) comprising numerous development services (e.g., editor, debugger, auto fill, intelligent assistance . . . ). By way of example, a programmer may choose to implement source code utilizing an object-oriented programming language (e.g., C#, VB, Java . . . ) where programmatic logic is specified as interactions between instances of classes or objects, among other things. Subsequently, the source code can be compiled or otherwise transformed to facilitate execution by a computer or like device.

A compiler conventionally produces code for a specific target from source code. For example, some compilers transform source code into native code for execution by a specific machine. Other compilers generate intermediate code from source code, where this intermediate code is subsequently interpreted dynamically at runtime or compiled just-in-time (JIT) to enable cross-platform execution, for instance. Further yet, some compilers are utilized by IDEs to perform background compilation to aid programmers by identifying actual or potential problems, among other things.

In general, compilers, perform syntactic and semantic program analysis. Syntactic analysis involves verification of program syntax. In particular, a program is lexically analyzed to produce tokens, and these tokens are parsed into syntax trees (or some other representation internal to the compiler) as a function of a programming language grammar. Typically, a parse tree is constructed during this phase. A parse tree is made up of several nodes and branches where interior nodes correspond to non-terminals of the grammar, and leaves correspond to terminals. Additionally or alternatively, an abstract semantic tree (AST) can be generated from the parse tree. The AST differs from the parse tree in that it omits edges and nodes associated with syntax that does not affect program semantics (as well, it often differs from an internal compiler data structure from which optimization, code generation, etc. are performed). The parse tree is subsequently employed to perform semantic analysis, which concerns determining and analyzing the meaning of a program. Also performed during this phase is type checking and binding.

Type checking is a process of verifying and enforcing type constraints. Programming languages employ type systems to classify data into types that define constraints on data or sets of values as well as allowable operations. This helps ensure program correctness, among other things. Accordingly, types are checked during the semantic analysis phase to ensure values and expressions are being utilized appropriately. In some instances, types are not explicit but rather need to be inferred from contextual information. Thus, type checking sometime necessitates type inference.

Knowledge of types is significant in a binding process, which associates a value with an identifier (name binding) or resolves a variable to its definition (variable binding), among other things. Some programming languages allow overloading of constructs such as functions or methods. More specifically, objects of different types can include the same function or method names. It is only after an object type is determined that the correct definition is known. Once known, the definition is bound.

However, program languages differ as to when binding occurs. Static or early-bound languages require binding at compile time. Dynamic or late-bound languages perform binding dynamically at runtime. Other languages employ a hybrid or dual approach in which they perform binding statically at compile time where possible and defer other binding to runtime. Here, two copies of the compiler, or a subset of functionality, are employed—one that operates at compile time to enable early binding and another that operates at runtime to perform late binding.

Expression trees are conventionally utilized as an internal data structure to facilitate capture, manipulation, and execution of programmatic code. For example, some program languages support language-integrated queries that resemble in syntax a structured query language (SQL) and in fact can target such an external database. In this case, the query can be captured by an expression tree for transmission to a target SQL database. In any event, expression trees are employed as an internal representation for a variety of specific tasks.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to generalized expression trees. More particularly, expression tree versatility and applicability are enhanced to support utilization across different programming languages and execution contexts, among other things. In accordance with one aspect of the disclosure, expression trees can provide a common representation for communication amongst different producers and consumers of code or programs represented as data.

Expression trees can be complete representations of code and semantics. In one instance, statements or programmatic constructs (e.g., variable assignment, control flow . . . ) can be modeled as special expressions to facilitate capture of entire programs or portions of programs. The expression tree can also included bound, dynamic, and/or unbound nodes to enable representation of static and dynamic programming language constructs. Further yet, expression trees can include annotations of nodes, or sets of nodes, that provide additional information to aid tree processing.

Additionally, language specific/unique constructs may be included when interacting and/or processing across different programming languages. In accordance with another aspect of the disclosure, language specific expression tree nodes can be reduced to primitive constructs/nodes of equivalent semantics. Further yet, nodes need not be reduced where use of custom producers and consumers is desired.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates computer program processing in accordance with an aspect of the disclosure.

FIG. 2 is a block diagram of a representative expression-tree component according to a disclosed aspect.

FIG. 3 is a block diagram of an expression tree including a variety of node types in accordance with an aspect of the disclosure.

FIG. 4a is a block diagram of a node-type transformation system according to an aspect of the disclosure.

FIG. 4b is a graphical illustration of node-type transformations to facilitate clarity and understanding in accordance with a disclosed aspect.

FIG. 5 is a block diagram of an expression-tree generation system including annotations according to an aspect of the disclosed subject matter.

FIG. 6 is a block diagram of an expression-tree reduction system according to a disclosed aspect.

FIG. 7 is a flow chart diagram of a method of expression tree generation in accordance with an aspect of the disclosure.

FIG. 8 is a flow chart diagram of a method of expression tree node binding in accordance with a disclosed aspect.

FIG. 9 is a flow chart diagram of a method of processing a language specific expression tree in accordance with an aspect of the disclosure.

FIG. 10 is a flow chart diagram of an expression-tree processing method in accordance with a disclosed aspect.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods pertaining to generalized expression trees are described in detail hereinafter. Expression trees are data structures utilized to facilitate compilation and execution of programmatic code. Modifications are made to expression trees to enable improved versatility and broaden applicability, among other things. Among other things, such modifications enable a common representation in the form of an expression tree across program languages and execution contexts. In one instance, statements (e.g., variable assignment, control flow . . . ) can be captured in an expression tree as a special expression to allow entire programs to be saved and accessed as expression trees. Further, expression tree nodes can be bound, unbound or dynamic to facilitate employment in various execution contexts (e.g., static, dynamic, dual . . . ). One or more nodes can also be annotated with additional information to facilitate processing. Still further yet, language specific concepts can be reduced to a common expression tree representation to allow language independent utilization where desired.

It is to be noted and appreciated that while some may refer to statement trees or a combination of statement and expression trees, as used herein “expression tree” is intended to refer to any data structure representing programmatic code for the purposes of semantic understanding, manipulation, compilation, execution, and so on.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

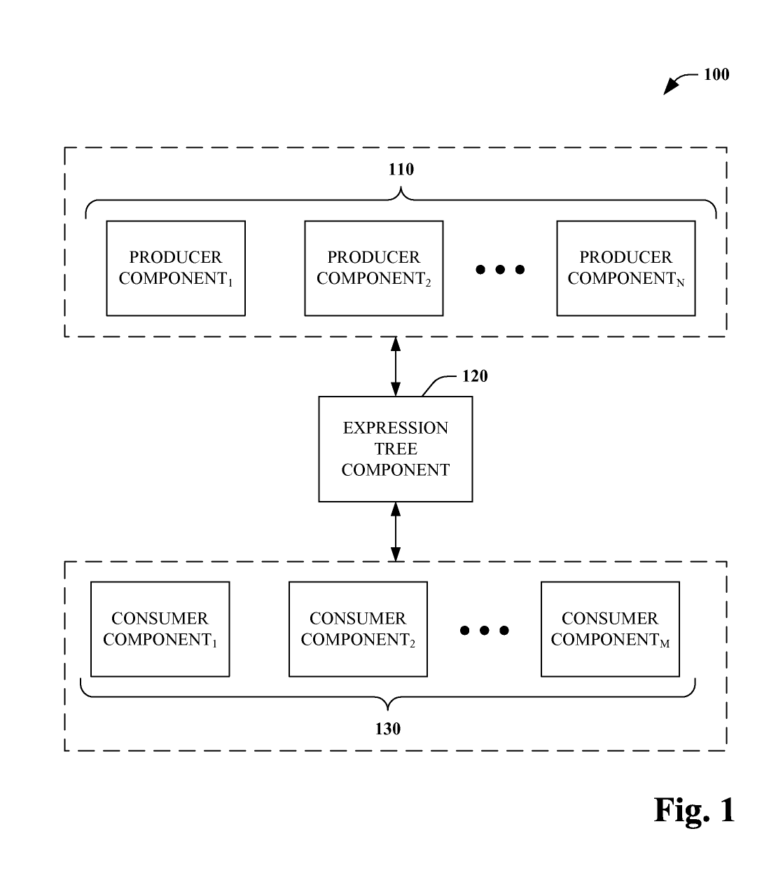

Referring initially to FIG. 1, a system 100 that facilitates computer program processing is illustrated in accordance with an aspect of the claimed subject matter. The system 100 includes a plurality of producer components 110 (PRODUCER₁ to PRODUCER_{N}, where N is an integer greater than one) that produce, generated or otherwise construct an expression tree component 120. In one embodiment, a producer 110 can correspond to a compiler or component/sub-component thereof. The expression tree component 120 is a data representation that provides a mixture of syntactic and semantic information that captures an entire or portion of a computer program. In other words, the expression tree component 120 records code as data. The expression tree component 120 is available for processing or consumption by one or more consumer components 130 (CONSUMER₁ to CONSUMER_{M}, where M is greater than or equal to one). Although not limited thereto, in accordance with one embodiment, the consumer components 130 can correspond to compiler components or subcomponents. Additionally or alternatively, a consumer component 130 can be a language runtime component.

According to one embodiment, the expression tree component can provide a common representation across multiple computer languages and/or execution contexts. As a result, it is to be appreciated that both producer components 110 and consumer components 130 can be associated with various computer programming languages as long as they support production and consumption of a common expression tree component 120, respectively.

By way of example and not limitation, consider a scenario in which a program is specified in a particular program language “A.” One or more compiler components can produce the expression tree component 120. In one instance, compiler components associated with language “A,” namely “A” compiler components, can generate the tree as a representation of the program. Subsequently, a number of consumer components 130 can employ the expression tree component 120 to perform some actions such a code optimization and code generation. However, such components need not be associated with program language “A” (although they could be). In fact, the code optimization component can be associated with language “B” (“B” code optimization component) and the code generation component associated with language “C” (“C” code generation component), among other combinations and/or permutations, assuming the components operate on the expression tree component 120.

Of course, the consumer components 130 are not limited to compiler components. For instance, a consumer component 130 can correspond to a code analysis component to facilitate understanding how a program operates. Accordingly, a particular compiler can be employed to produce the expression tree component 120 and a code analysis component associated with the same or different language can be utilized to analyze a program. In another non-limiting example, a program runtime or runtime library component can be a consumer component 130. In this case, dynamic type checking, debugging, and/or array bound checking, amongst other runtime functionality, can be performed utilizing the expression tree component 120.

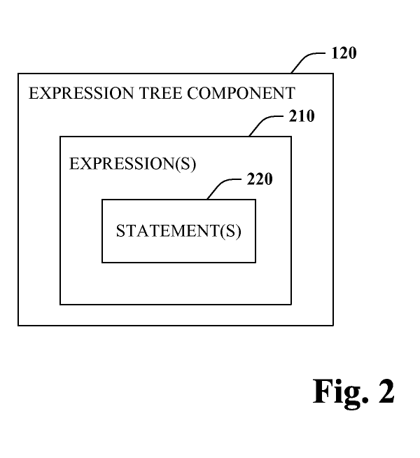

Turning attention to FIG. 2, a representative expression-tree component 120 is depicted in accordance with an aspect of the claimed subject matter. A programming language can include two expressive mechanisms, namely expressions and statements. As with conventional expression trees, the expression tree component 120 can include or represent one or more expressions 210 such as “a+b” or “x<y” Furthermore, the expression tree 120 can represent statements 220 as special expressions. Statements 220 refer programmatic constructs, elements or the like (e.g., variable assignment, built-ins, control flow (if statements, switch statements, while loops . . . ) . . . ). Expressions generally return a value while statements typically do not. Accordingly, statements can be modeled as “void” returning expressions in some cases. Consider a series of statements that can also be represented by the expression tree component 120 such as “Console.WriteLine(“Hello”); Console.WriteLine(“World”)”. This can be interpreted as an expression composed of a sequence of two void returning expressions separated by the syntax“;”. Of course, it is also possible that statements may return a value in which case they would resemble standard expressions with a non-void return type. Since statements can be represented as special expressions, the term “expression” is utilized hereinafter to refer to both conventional expressions and special expressions, unless otherwise noted.

By integrating statements 220 with expressions 210 entire programs or portions of programs can be captured by the expression tree rather than simple expressions. In other words, programs or code can be represented as data in the form of an expression tree. Further, where this code representation is common, processing can be shared amongst any number of components that support the representation. Furthermore, components that operate on code do not need to write their own parsers since a common parser component may be shared amongst many consumers in a common way. As described above, a common representation of code can enable certain compiler phases or passes (e.g., optimization, code generation . . . ) to be shared between various compilers, for example. There are many kinds of programs that operate on other programs whose code is represented as data (expression trees).

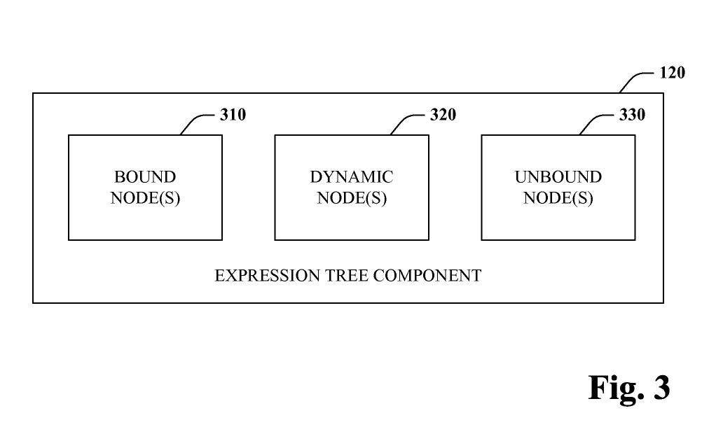

FIG. 3 illustrates an expression tree 120 including a variety of node types in accordance with an aspect of the claims. Expression trees include a plurality of nodes and branches, where nodes are constructs and branches identify the relationship between constructs. For example, an inner node can be an operator while leaf nodes are operands, and the branches represent the relationship between operators and operands. In accordance with one aspect, expression tree nodes can be bound nodes 310. Bound nodes 310 refer to nodes that are bound to particular static types and/or definitions, such as those provided by a runtime or platform. For instance, in an expression “a+b” the two leaf nodes can be bound to type “Integer”. Here, “a” and “b” are bound nodes.

Expression tree nodes can also be dynamic nodes 320, where the node is dynamically bound to a type and/or definition at runtime. In other words, there may not be enough context information available to bind the node a compile time, but there should be enough information to perform binding dynamically at runtime.

Unbound nodes 330 are also possible for the expression tree 120. Unbound nodes are neither bound nor dynamically bound at compile time. However, at runtime unbound nodes will become either bound or dynamic as other nodes transition from dynamic to bound or from unbound to dynamic or bound. Unbound nodes often appear as children of dynamic nodes. This can occur with respect to lambda expressions and query comprehensions, amongst others. By way of example and not limitation, when the lambda expression “(c)=>c>10” appears inside an expression such as “o.where((c)=>c>10)” the lambda expression cannot be bound when “o.where” is dynamic. The lambda remains unbound until “o.where” becomes bound, and then the lambda can be bound within that dynamic binding at runtime.

In general, places in programming languages can exist where a particular expression can be bound only where enough context information is known. For example, an expression can be bound when surrounding expressions are bound. Typically, expressions are bound from bottom up. However, in certain cases they should be bound the other way around. By contrast, if an enclosing expression is dynamically bound then any internal expression has to wait to be bound until the enclosing expression is bound first. Essentially, the internal expression is kept around as unbound until the enclosing expression is bound at runtime.

Expression trees can be entirely bound or dynamic or include a combination of bound, dynamic, and unbound nodes. For static languages, for instance, all names or references are bound at compile time. That is, the static type of each variable declaration and all method calls are resolved at compile time. Consequently, all nodes associated with a program specified in a static language will be bound. Alternatively, where a program is denoted in a dynamic programming language, binding may not be performed until runtime, thus most nodes will be dynamic with the possibility of some unbound nodes. Further, where a program is specified in a hybrid static/dynamic language various combinations of nodes are possible. By way of example, consider a hybrid or dual programming language supporting both static and dynamic binding. Since parts can be statically bound, a static call can be passed to an object that is dynamically bound such that a late bound call can be performed with the result of that static call. This can be captured utilizing bound and dynamic nodes, 310 and 320, respectively, in the expression tree 120.

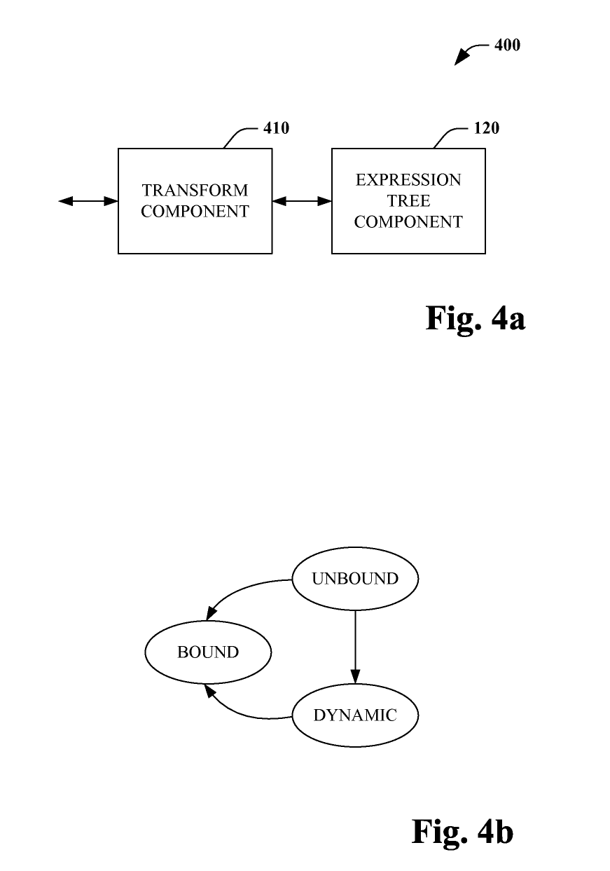

Referring to FIG. 4a, a node-type transformation system 400 is illustrated in accordance with an aspect of the claimed subject matter. As shown, the system 400 includes a transform component 410 communicatively coupled to an expression tree component 120, as previously described. Based on actions by a type binder component and/or an overload resolution component, amongst others, the transform component can transform or alter a node type. As depicted graphically in FIG. 4b, types can be transformed from dynamic to bound and/or unbound to dynamic or bound. Stated differently, dynamic nodes can be converted to bound type at runtime, whereas unbound nodes can be transformed either to dynamic or bound type at runtime. Although not graphically depicted, other transformations are also at least theoretically possible such as from bound to bound, unbound, or dynamic.

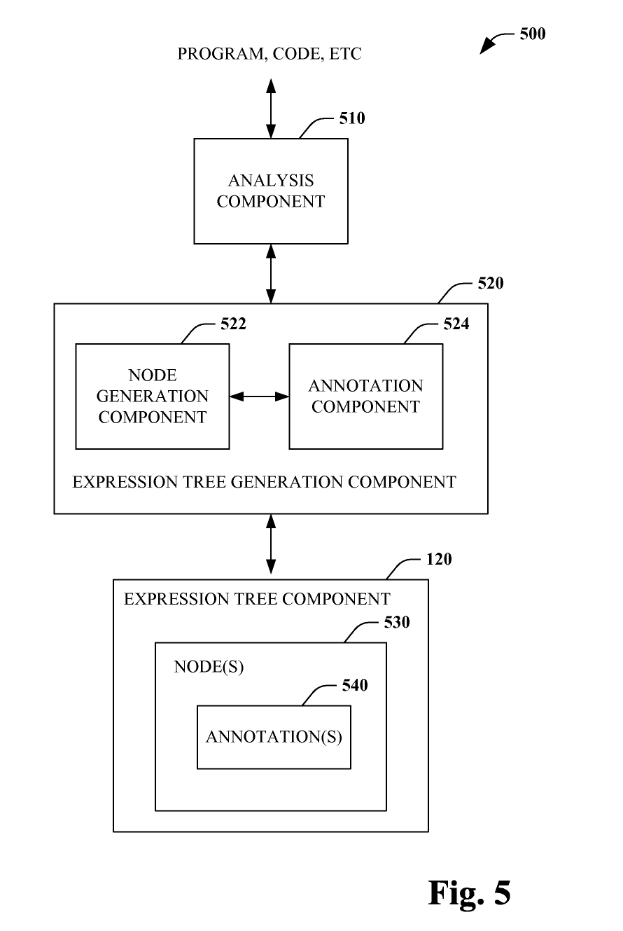

FIG. 5 shows an expression-tree generation system 500 in accordance with an aspect of the claimed subject matter. The system 500 includes an analysis component 510 and an expression-tree generation component 520. The analysis component can analyze, scan, and/or parse a particular program or portion thereof. The expression-tree generation component 520 is communicatively coupled to the analysis component 510 to facilitate production of an expression tree component 120 based on the functionality provided thereby. In particular, the expression-tree generation component 520 includes a node generation component 522 that constructs expression tree nodes 530 for expressions or constructs comprising expressions.

Furthermore, the expression-tree generation component 520 includes an annotation component 524 to add annotations 540 or additional information to one or more nodes 530 or a set of nodes 530. It is not always possible a priori to know what information is needed in expression tree nodes, or what information you may need to apply later. Various languages and/or process mechanisms may want to record additional information inside nodes. For example, a reference may be included to original code such as the location thereof and/or line number associated with an expression. In this case, a debugger can later display code in an editor while the code is being debugged. In another instance, a compiler phase can annotate the expression tree with something specific to the phase and later remove it or save it for subsequent phases.

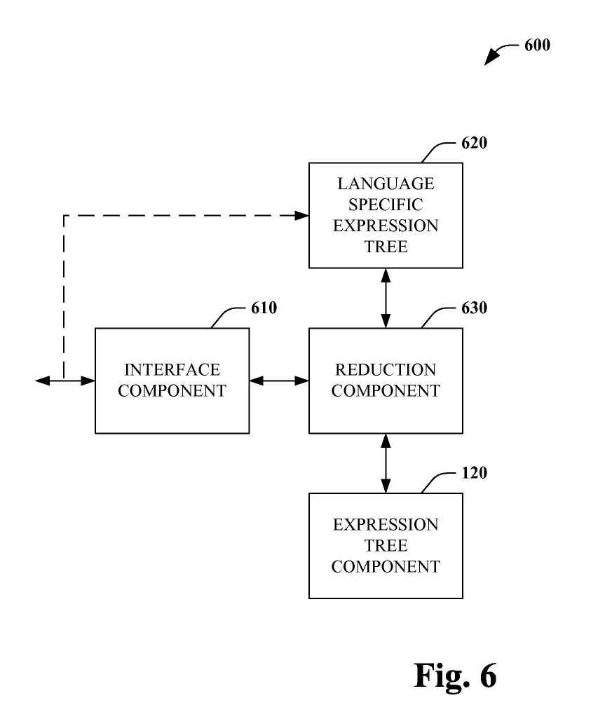

Referring to FIG. 6, an expression-tree reduction system 600 is depicted in accordance with an aspect of the claimed subject matter. The system 600 includes an interface component 610 to receive a request to reduce and/or identification of a language specific expression tree 620 and/or node for reduction. This information is available to reduction component 630 and can initiate reduction of a language specific expression tree or portion thereof (e.g. node(s)) to a common expression tree component 120. It is to be noted that in accordance with an alternate embodiment, functionality associated with reducing a node is encapsulated in the node. Accordingly, expression tree nodes receive requests to be reduced and subsequently initiate reduction of themselves from a language specific expression tree 620 to a common expression tree 120.

There is a tension in modeling between common and specific. Often times modeling is simply directed to a least common denominator—only a subset of features that all things include. Thus, some specific functionality is unavailable. Alternatively, more specific and rich modeling is directed to features included by only one or a small few languages. This limits utilization of common tools. In accordance with an aspect of the claimed subject matter, a balance is struck between the two approaches. More particularly, language specific expression trees can be employed where desired. Additionally, the specifics of an entire tree or portion thereof can be reduced to a common expression tree representation to enable use with common tools, programs, processes, or the like.

Most programming language constructs can be mapped down or reduced to a small set of primitive constructs. For instance a “while loop” or “if-then-else” statement can be reduced to some statement sequence of “gotos”, as an example, not to imply that iteration constructs and conditionals do or do not reduce to gotos. This generalizes a language specific construct to a set of known constructs that are semantically equivalent. In other words, each language can define language specific nodes that can be reduced to a set of nodes that represent core constructs. Core constructs may or may not be primitive, sometimes themselves reducing to other core constructs that are primitive. This is significant since each language usually has a different set of higher-level control structures, among other things, yet expression trees support a common set of constructs.

There is a distinction between locally reducible and globally reducible. The term locally reducible means that only a portion of an expression tree (e.g., language specific expression), represented by an expression tree node and nodes that are direct or indirect descendents of that node, will be reduced, while other sub-trees remain unchanged. By contrast, globally reducible means additional portions of a tree, such as non-local sub-trees (navigated to by going higher in the tree and descending subtrees along other paths), are also modified. Hence, reduction component 630 can return a completely new expression tree different from the language specific expression tree 620 or modify only pieces of it. In certain contexts, reduction of complex expressions into primitive expressions cannot be done locally. For example, a language declaration such as “On Error Goto” can have a global effect of branching around subtrees well outside the subtree starting with the “On Error Goto” node. Accordingly, where an expression has a non-local effect global reducibility can be employed.

Reduction enables a common representation that can be employed or consumed by a numerous tools, processes, and the like without regard for a specific programming language. Consumers 130 described in FIG. 1 do not need to know specific languages. The consumers 130 will work for all languages regardless of what special nodes they include, because where a node cannot be understood, it can be reduced to something that is understood. Instead of requiring consumers to know about everything a common, generalized or language agnostic representation is fixed as a communication protocol that is employed by all. Rather than employing a true open-end representation, benefits of a closed-end representation are obtained. At the same time, language specificity can also be maintained such that only specific consumers will comprehend the representation.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the reduction component 630 can include such mechanisms to facilitate reduction of language specific constructs to a common expression tree representation by inferring or otherwise determining a semantically equivalent representation from known or learned information.

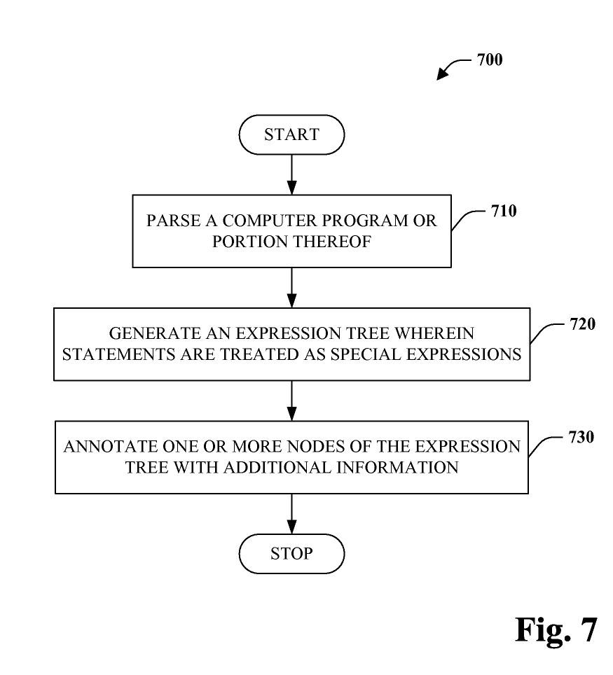

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of expression tree construction 700 is illustrated in accordance with an aspect of the claimed subject matter. At reference numeral 710, a computer program or portion thereof is parsed. Parsing can involve scanning over a program and identify particular elements such as tokens. At numeral 720, an expression tree is generated wherein statements such as control flow elements, among others, are treated as special expressions. For example, an “if” statement can be treated as a “void” returning expression. In this manner, entire programs or portions thereof can be captured and saved as data rather than or in addition to simple expressions. At reference numeral 730, one or more nodes of the expression tree can be annotated with additional information. For example, original code reference and/or and associated information such as line numbers can be includes as annotations to one or more nodes or sets of nodes.

It is to be noted and appreciated that implementation of expression-tree construction method 700 can vary in many ways including but not limited to single or multiple pass execution. For instance, a parse tree can be generated at 710 that is subsequently employed to produce an alternative expression tree representation at 720, which later can be annotated. On the other hand, parsing and expression tree generation can occur within a single phase and annotation included therewith or provided in another phase. For example, annotation need not be part of the initial expression tree construction at all but rather information can be added to the expression tree or a copy thereof by a particular consumer, which may or may not be removed subsequent to processing.

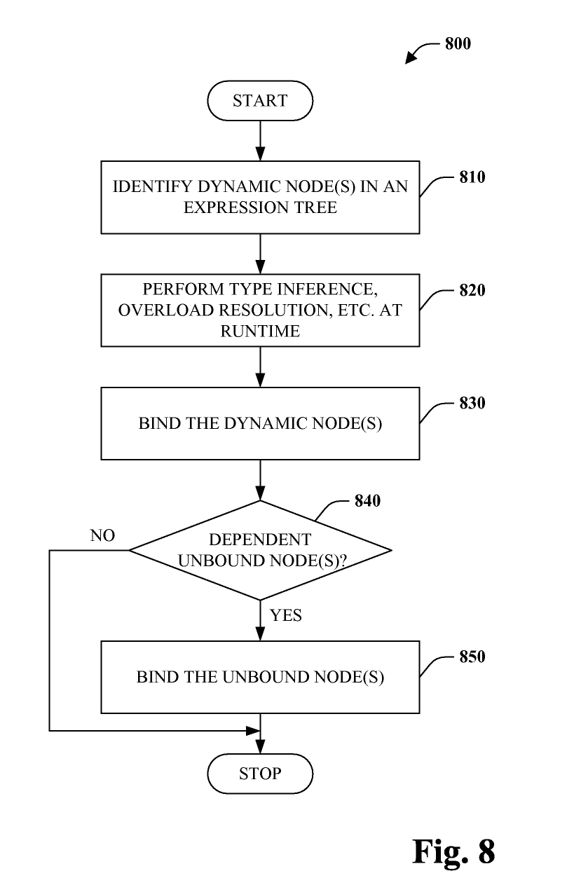

FIG. 8 depicts a method 800 of binding over expression tree nodes in accordance with an aspect of the claimed subject matter. At reference numeral 810, dynamic node(s) are identified in an expression tree. Dynamic nodes are those constructs that cannot be bound until runtime. At numeral 820, type inference, overload resolution, among other things can be performed at runtime. Dynamic nodes are then bound at reference numeral 830. At reference 840, a determination is made concerning whether any dependent unbound nodes exist. As previously mentioned, an expression tree can include bound, dynamic and/or unbound nodes, where unbound nodes can be a child of a dynamic node such as in the case of lambda expressions (e.g., “o.Where((d)=>d>0)”, where “o” is late bound), among others. If there are no unbound nodes as determined at 840 (“NO”) then the method can simply terminate. Otherwise, if there are unbound nodes (“YES”), the method continues at reference numeral 850 where the unbound node(s) are bound or otherwise transformed to dynamic nodes.

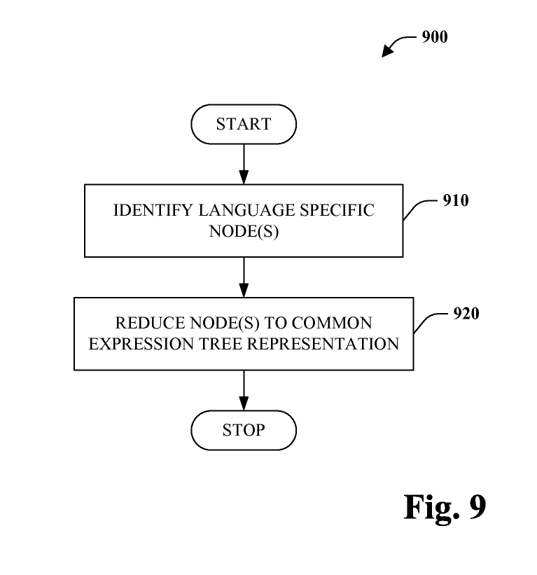

FIG. 9 depicts a method 900 of processing language specific expression trees in accordance with an aspect of the claimed subject matter. Tree producer components can produce language specific trees. More specifically, such trees can be generated with language specific nodes. At reference numeral 910, such language specific nodes are identified. Where such a tree is processed by a custom language consumer, the language specific nodes are not an issue. However, where processing is desired with respect to a common, generalized expression tree such nodes are reduced or transformed to primitive nodes/constructs of equivalent semantics supported by the representation at numeral 920. Reduction can be local or global depending upon the nature of a language specific construct. Where such a construct has a non-local or global effect, for example, global reduction can be performed.

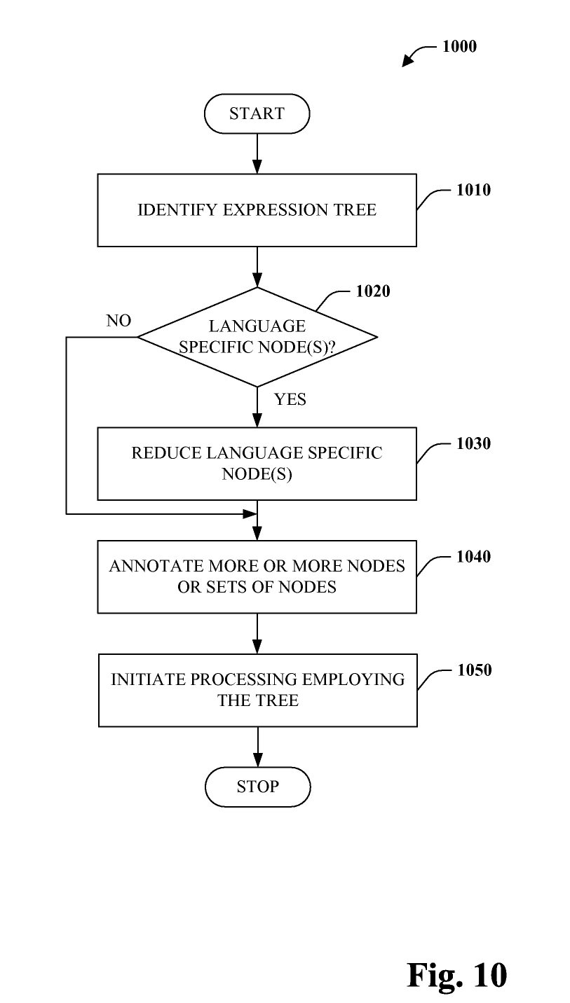

Turning attention to FIG. 10 a flow chart diagram of a method of expression tree processing 1000 is illustrated. At reference numeral 1010, an expression tree is identified. The expression tree corresponds to a data structure that captures code as data for saving, transmission, and execution, amongst other processes. A determination is made at reference 1020 concerning whether the expression tree includes language specific nodes. If yes, the method proceeds at numeral 1030 where languages specific nodes are reduced or generalized to a common representation, for example by replacing language specific nodes with a subtree comprising one or more primitive nodes that taken together represent the same semantics. Next, the method proceeds to reference numeral 1040. If there are no language specific nodes detected at reference 1020, the method bypasses act 1030 and continues at numeral 1040 where one or more nodes or sets of nodes are annotated. Nodes can be annotated with additional information that may be helpful in performing some particular action. At numeral 1050, processing is initiated with respect to the expression tree. Among other things, processing can include compilation processes, phases or passes as well as debugging, among other things. In accordance with one aspect, the expression tree can be employed to generate code for execution (e.g., intermediate language code) or interpreted during runtime.

The term “binding” or various forms thereof is intended to refer to association of a programmatic construct or representation thereof to a value, definition, or implementation, among other things. By way of example and not limitation, binding can refer to name binding in which a value is associated with an identifier or variable binding that associates a variable with its definition.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

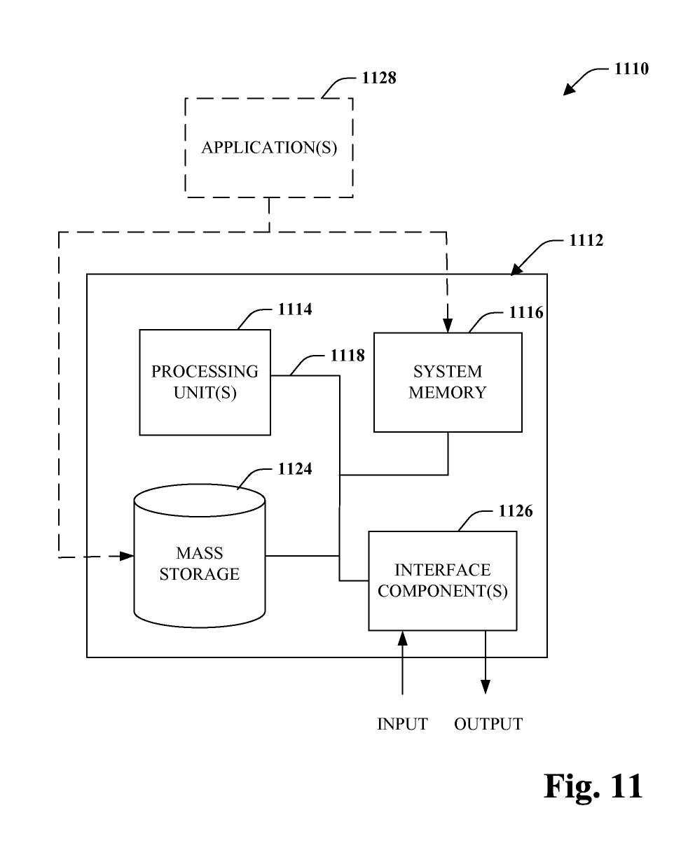

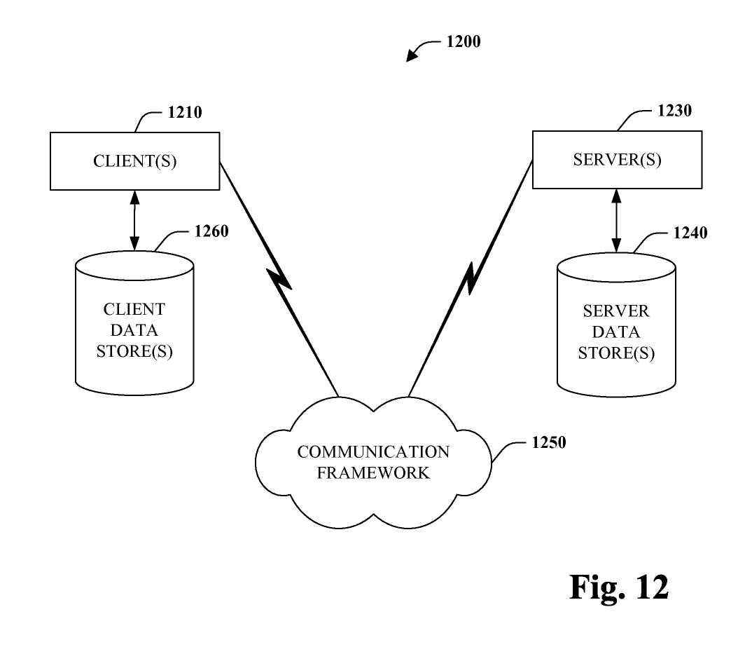

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 11 18. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. By way of example and not limitation various expression tree producers and/or consumers can implemented as services. For instance, code can be developed on a client 1210 and transferred to a server 1230 across communication framework 1250 for generation of an expression tree as described herein for return directly to the client 1210 or transmission to another service for subsequent processing (e.g., reduction, annotation . . . ).

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system to facilitate computer program processing, comprising:
a computer-readable medium; and
a producer component that generates an expression tree that captures syntax and semantics of a computer program in a form common to multiple programming languages and stores the expression tree at least temporarily on the computer-readable medium.

2. The system of claim 1, the expression tree represents program statements as special expressions.

3. The system of claim 2, the statements are represented as void returning expressions

4. The system of claim 1, the expression tree includes unbound, and/or dynamic nodes.

5. The system of claim 1, the expression tree includes bound nodes.

6. The system of claim 1, a node or set of nodes comprising the expression tree includes one or more annotations that provide additional information related to the particular node or set of nodes.

7. The system of claim 1, the producer component generates the expression tree from source text, a language specific syntax tree, and/or a language-specific semantic tree.

8. The system of claim 7, the expression tree comprising a reducible node that reduces from a language specific concept it models to a common model.

9. The system of claim 8, the reducible node transforms language specific constructs to primitive language constructs of equivalent semantics.

10. The system of claim 8, the reducible node performs global reduction on the entire language specific tree or sub-tree.

11. The system of claim 1, further comprising a consumer component that performs an action based at least in part of the expression tree.

12. The system of claim 11, the consumer component is a runtime service.

13. An expression-tree production method, comprising:
parsing at least a portion of a computer program; and
generating an expression tree common to multiple languages or with specific nodes, wherein language constructs are represented as expressions.

14. The method of claim 13, further comprising generating at least one of an unbounded or dynamically bound node.

15. The method of claim 13, further comprising annotating at least one or a subset of expression tree nodes with additional information.

16. The method of claim 13, further comprising reducing a program language specific construct to a primitive constructs of common representation.

17 The method of claim 16, performing one of local reduction of a portion of the expression tree or global reduction of the entire tree or sub-tree.

18. A computer-readable medium having stored thereon a data structure, comprising:
an expression tree comprising a one or more nodes that provide a common syntactic and semantic representation for a computer program across multiple computer languages, wherein one or more nodes are bound, unbound, or dynamic.

19. The computer-readable medium of claim 18, program code constructs are represented as expressions.

20. The computer-readable medium of claim 18, at least one node or set of nodes are annotated with additional information.
